(19) United States
(12) Patent Application Publication
(10) Pub. No.: US 2019/0029452 A1
(43) Pub. Date: Jan. 31, 2019

(54) DISPOSABLE PROTECTIVE SHIELD SYSTEM

(71) Applicant: Dilsia Rodriguez, II, Roysa City, TX (US)

(72) Inventor: Dilsia Rodriguez, II, Roysa City, TX (US)

(21) Appl. No.: 16/031,402

(22) Filed: Jul. 10, 2018

Related U.S. Application Data
(60) Provisional application No. 62/530,615, filed on Jul. 10, 2017.

(51) Int. Cl. A47G 27/02; E03D 9/00

(52) U.S. Cl. CPC A47G 27/0225; E03D 9/00; B32B 2307/7265; B32B 2250/03; B32B 2471/04

(57) ABSTRACT

A disposable protective shield system enables the prevention of escaped fluids from a toilet from reaching the floor around a toilet. A mat is placed in front and covers the side areas as well. The mat allows the fluids pass through a permeable layer where they are sequestered by an absorbent layer and prevent from exit by a non-permeable layer. The mat could have varying fluid capacity in the absorbent layer, folding flaps to extent the area protected by the mat. Wall shields are attached to the walls around the toilet to protect them from escaping fluids.

### BACKGROUND

### 1. Field of the Invention

The present invention relates generally to sanitary protection systems, and more specifically, to a disposable protective shield system for preventing undesirable fluids such as urine from reaching a floor.

### 2. Description of Related Art

Sanitary protection systems are well known in the art and are effective means to protect the immediate area around a toilet. For example, FIG. 1 depicts a conventional rubber mat device 101 having a shaped mat 103 with a plastic top surface 105 placed in front of a toilet 107. During use, the mat 101 prevents urine from reaching the floor around the toilet.

One of the problems commonly associated with system 101 is limited use. For example, often urine passes beyond the coverage of the mat 101 soiling the floor, walls or other items near the toilet 107.

Additionally, if the mat 101 does catch the urine it must be cleaned to prevent contamination of other surfaces or items.

Accordingly, although great strides have been made in the area of rubber mat devices, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a top view of a common rubber mat device;

FIG. 2 is a front view of a disposable protective shield system in accordance with a preferred embodiment of the present application;

FIG. 3 is a cross-sectional front view of the mat of FIG. 2;

FIG. 4 is a top view of an alternative embodiment of the mat of FIG. 2;

FIG. 5 is a top view of an alternative embodiment of the mat of FIG. 2;

FIG. 6 is front view of an alternative embodiment of the system of FIG. 2;

FIG. 7 is a cross-sectional top view of the wall shields of FIG. 6; and

FIG. 8 is a flowchart of the preferred method of use of the systems of FIGS. 2 and 6.

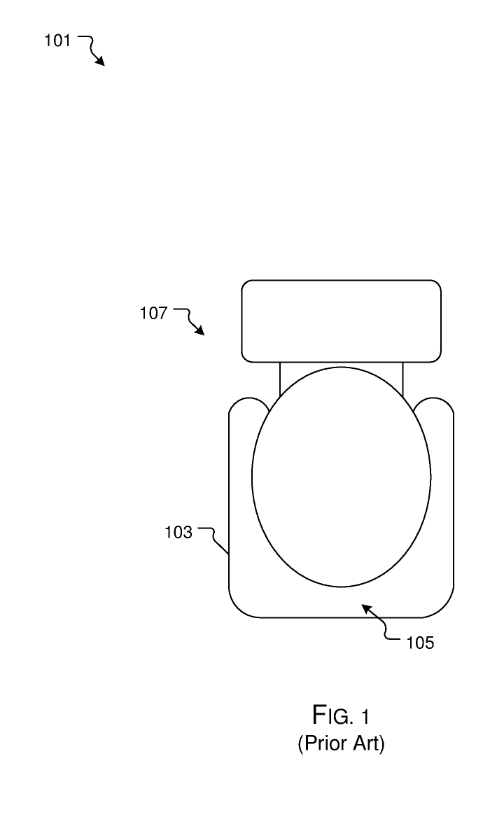

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional rubber mat devices. Specifically, the invention of the present application increases the likelihood of capturing any urine or other fluids that escapes the toilet. In addition, the system of the present application is disposable eliminating the need to clean any urine or other fluids. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Referring now to the drawings wherein like reference characters identify corresponding or similar elements throughout the several views, FIG. 2 depicts a front view of a disposable protective shield system in accordance with a preferred embodiment of the present application. It will be appreciated that system 201 overcomes one or more of the above-listed problems commonly associated with conventional rubber mat devices.

In the contemplated embodiment, system 201 includes a shield 203 configured to cover the area in front of and on the sides of a toilet 205. The shield 203 having a non-permeable layer 301, an absorbent layer 303 and a fluid permeable layer 305 configured to act as one body.

In use, the shield 203 is placed around the base of the toilet 205 and captures any fluid such as urine that escapes the toilet. The fluid passes through the permeable layer 305 and is captured by the absorbent layer 303. Non-permeable layer 301 prevents the fluid from escaping the shield 203.

It should be appreciated that one of the unique features believed characteristic of the present application is that shield 203 can be discarded after multiple uses when absorbent layer 303 becomes saturated.

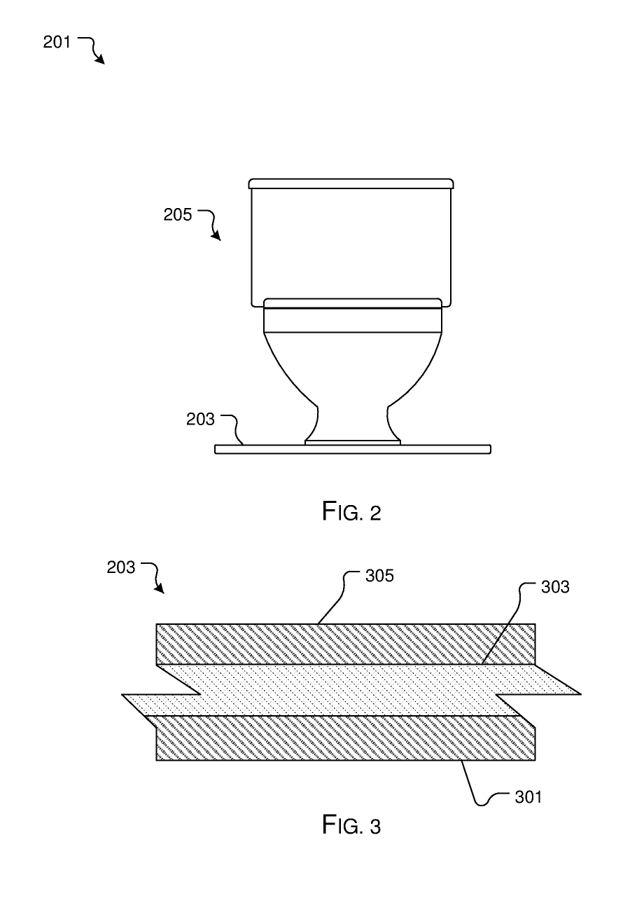

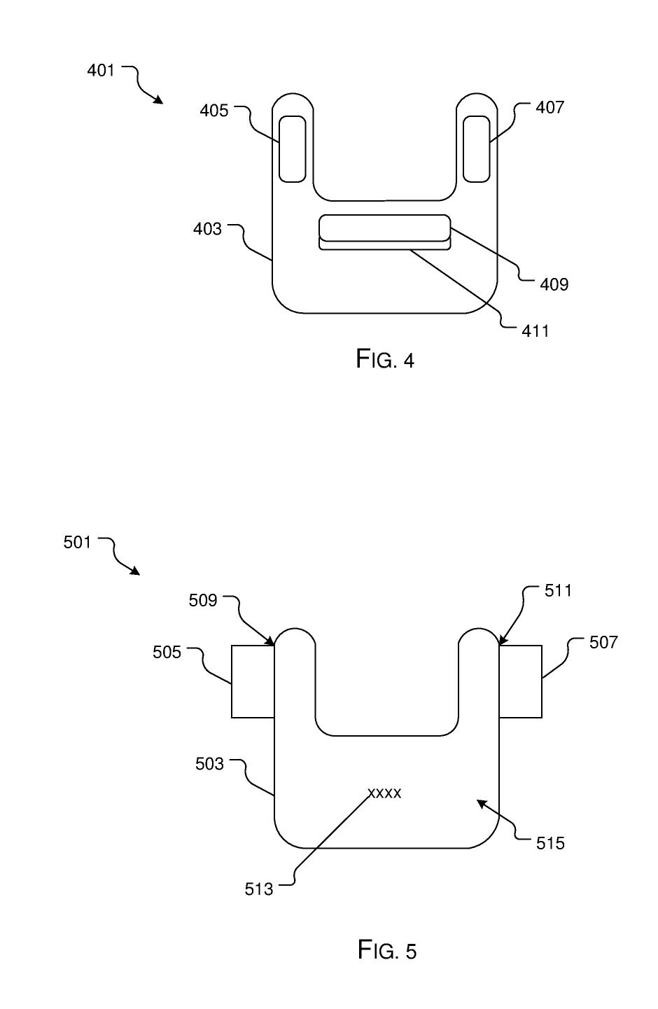

Referring now to FIG. 4 an alternative embodiment of the mat 203 is depicted. Embodiment 401 including a body 403 having absorbent material arranged in critical areas 405, 407, 409. It will be appreciated that absorbent areas 405, 407, 409 contain a non-homogenous fluid capacity e.g. a higher capacity compared to the remainder of the mat. It will be understood that areas 405, 407, 409 are enclosed by permeable and non-permeably layers as depicted in FIG. 3 and that this embodiment demonstrates the increased capacity to absorb fluid in these areas 405, 407, 409.

Embodiment 401 also having an area of fluid activated material 411. The fluid activated material 411 attached or in proximity to the absorbent material 405, 407, 409. It will be understood that the fluid activated material 411 could be an odor absorber or fragrance release agent.

Another alternative embodiment of the mat 203, 401 is depicted in FIG. 5. Embodiment 501 including a body 503 having flaps 505, 507 flexibly attached to the sides 509, 511 of the body 503 respectively. It will be appreciated that the floor around a toilet could be of varying size and that flaps 505, 507 enable the protection of this floor space. Flaps 505, 507 fold under the mat 501 if not used.

Mat 501 also having indicia 513 on the top surface 515 of the mat 501. It is contemplated that the indicia 513 could be decorative or functional, such as indicating the saturation of the absorbent layer.

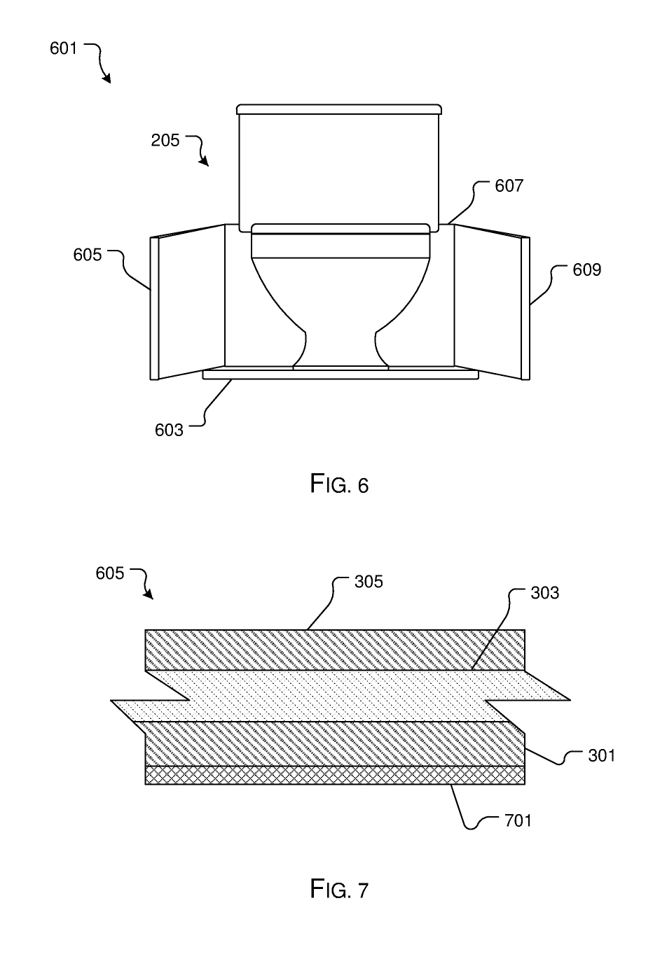

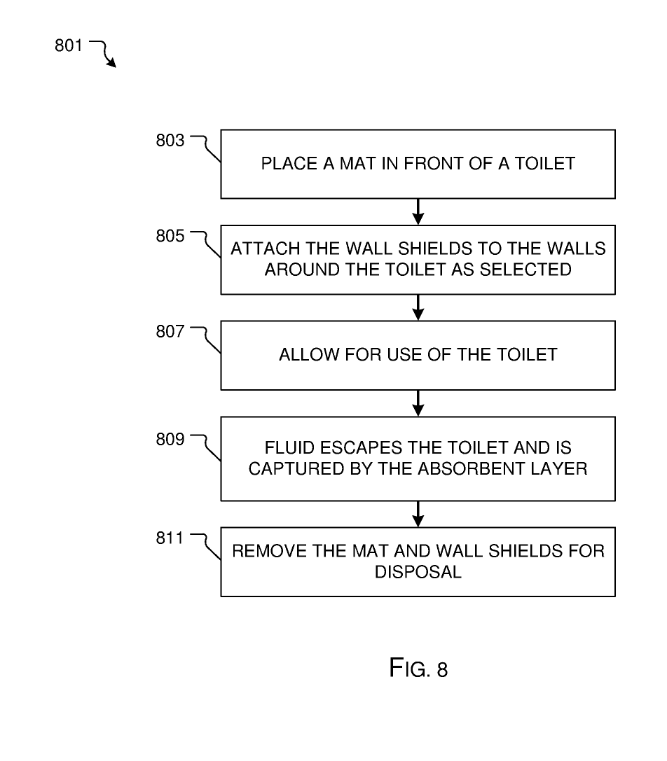

Referring now to FIG. 6 an alternative embodiment of the system 201 is depicted. Embodiment 601 including a mat 603 placed on the floor in front of and around a toilet 205. Mat 603 removably attached to a first side wall shield 605 a back wall shield 607 and a second side wall shield 609. The side wall shields 605, 609 being attached the back wall shield 607.

The wall shields 605, 607, 609 having the same features as mat 203 and including an adhesive layer 701 attached to the non-permeable layer. It will be appreciated that wall shields 605, 607, 609 enable the protection of the walls around a toilet 205.

Referring now to FIG. 8 the preferred method use of the systems 201, 601 is depicted. Method 801 including placing a mat in front of a toilet 801, attaching the wall shields of system 601 to the walls around the toilet 805, allowing for use of the toilet 807, fluid escaping the toilet and being captured by the absorbent layer 809 and removing the mat and wall shields for disposal 811.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A disposable protective shield system comprising:
a toilet; and
a mat having a non-permeable layer, absorbent layer and permeable layer attached to form a single body;
the mat configured to be placed in front of and around the toilet;
wherein the mat protects the floor around the toilet from escaping fluids from the toilet while in use.

2. The mat of claim 1 wherein the absorbent layer has non-homogenous liquid capacity in areas where fluid is expect to contact the mat.

3. The mat of claim 1 wherein the body of the mat has flaps attached to the sides of the mat that fold out to expand the coverage area of the mat.

4. The mat of claim 1 wherein the body has at least one area of fluid activated material.

5. A disposable protective shield system comprising:
a plurality of wall shields that removably attach to the walls around a toilet via an adhesive layer joined to a non-permeable.

6. A method of protecting the surfaces around a toilet given the system of claim 1 or 5, comprising:
placing a mat in front of a toilet;
attaching the wall shields to the walls around the toilet if selected;
allowing for use of the toilet;
fluid escaping the toilet and being captured by the absorbent layer; and
removing the mat and wall shields for disposal.
